(19) United States
(12) Patent Application Publication
(10) Pub. No.: US 2023/0048513 A1
(43) Pub. Date: Feb. 16, 2023

(54) INTELLIGENT CLOUD SERVICE HEALTH COMMUNICATION TO CUSTOMERS

(71) Applicant: Microsoft Technology Licensing, LLC, Redmond, WA (US)

(72) Inventors: Xiaofeng GAO, Redmond, WA (US); Zhangwei XU, Redmond, WA (US); Stephen M. PETERS, Redmond, WA (US); Hwaji YOU, Sammamish, WA (US); Tejasvee BOLISETTY, Bothell, WA (US); Pochian LEE, Sammamish, WA (US); Jian SUN, Newcastle, WA (US); Li YANG, Bellevue, WA (US)

(21) Appl. No.: 17/403,734

(22) Filed: Aug. 16, 2021

(51) Int. Cl. G06Q 30/00; G06Q 30/02; G06F 9/54; G06N 5/04; H04L 29/08

(52) U.S. Cl. CPC G06Q 30/016; G06F 9/542; G06N 5/04; G06Q 30/0205; H04L 67/10

(57) ABSTRACT

Example aspects include techniques for accurate and expeditious cloud service health communication to customers. These techniques may include determining that a service health incident has customer impact, the service health incident corresponding to an outage of one or more services of a cloud computing platform, identifying a plurality of customers impacted by the service health incident, and predicting, based on the service health incident and one or more other service health incidents, aggregated incident information identifying a plurality of service health incidents associated with the outage of the one or more services. In addition, the techniques may include identifying the one or more services associated with the service health incident, and transmitting, based at least in part on the aggregated incident information and the one or more services, a health notification to the plurality of customers.

### BACKGROUND

Cloud computing platforms experience outages that impact customer usage and may provide customers notification of the outages. Traditionally, cloud computing platforms employed dedicated communication personnel who were trained to send service health communications regarding the health of the cloud computing platform. However, relying on communication managers has proven to be error prone and failed to meet preferred time-to-notify goals for a critical customer facing endeavor. Further, some cloud computing platforms have employed communication managers that have overwhelmed customers with excessive amounts of notifications. Furthermore, customers may perform mitigative procedures in response to a cloud computing system outage. Consequently, untimely and/or inaccurate health communications prevent customers from reducing the impact of outages at a cloud computing platform.

### SUMMARY

The following presents a simplified summary of one or more implementations of the present disclosure in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations of the present disclosure in a simplified form as a prelude to the more detailed description that is presented later.

In an aspect, a method may include determining that a service health incident has customer impact, the service health incident corresponding to an outage of one or more services of a cloud computing platform, and predicting, based on the service health incident and one or more other service health incidents, aggregated incident information identifying a plurality of service health incidents associated with the outage of the one or more services. Further, the method may include identifying the one or more services associated with the service health incident, identifying a plurality of customers impacted by the service health incident, and transmitting, based at least in part on the aggregated incident information and the one or more services, a health notification to the plurality of customers.

In another aspect, a device may include a memory storing instructions and at least one processor coupled with the memory and configured to execute the instructions to determine that a service health incident has customer impact, the service health incident corresponding to an outage of one or more services of a cloud computing platform, and predict, based on the service health incident and one or more other service health incidents, aggregated incident information identifying a plurality of service health incidents associated with the outage of the one or more services, identify the one or more services associated with the service health incident. Further, the at least one processor may be further configured to identify a plurality of customers impacted by the service health incident, and transmit, based at least in part on the aggregated incident information and the one or more services, a health notification to the plurality of customers.

In another aspect, an example computer-readable medium storing instructions for performing the methods described herein and an example apparatus including means of performing operations of the methods described herein are also disclosed.

Additional advantages and novel features relating to implementations of the present disclosure will be set forth in part in the description that follows, and in part will become more apparent to those skilled in the art upon examination of the following or upon learning by practice thereof.

### BRIEF DESCRIPTION OF THE DRAWINGS

The Detailed Description is set forth with reference to the accompanying figures, in which the left-most digit of a reference number identifies the figure in which the reference number first appears. The use of the same reference numbers in the same or different figures indicates similar or identical items or features.

FIG. 1 is a diagram showing an example of a cloud computing system, in accordance with some aspects of the present disclosure

FIG. 2 illustrates an example of a graphical user interface displaying incident information, in accordance with some aspects of the present disclosure.

FIG. 3 is a flow diagram illustrating an example method for implementing intelligent cloud service health communications, in accordance with some aspects of the present disclosure.

FIG. 4 is a block diagram illustrating an example of a hardware implementation for a cloud computing device, in accordance with some aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes techniques for implementing intelligent cloud service health communications for a cloud computing platform. In particular, aspects of the present disclosure provide a system configured to determine the impact of an outage to one or more services of a cloud computing platform, and accurately and expeditiously communicate cloud service health communications to customers impacted by the outage. Accordingly, for example, a cloud service provider may employ a service health management module to perform an intelligent method that reduces time to notify and accuracy of health communications.

In a cloud infrastructure environment, providing customers with outage information is a largely inefficient process as many environments are unable to quickly and/or accurately determine health information to provide to customers. In accordance with some aspects of the present disclosure, a service health management module may be configured to determine whether there is customer impact for an outage, determine which customers are impacted across all services of the cloud computing platform, continuously monitor health incident status corresponding to the outage, continuously perform impact assessments, periodically send incident communications based on newly-identified impact information (e.g., customers recently identified as being impacted by an outage), intelligently compose incident communications for different stages of an outage, and enable just-in-place communication. Accordingly, the systems, devices, and methods described herein provide techniques for implementing intelligent cloud service health communications to quickly provide customers with accurate outage information without sending excessive amounts of health communications.

### Illustrative Environment

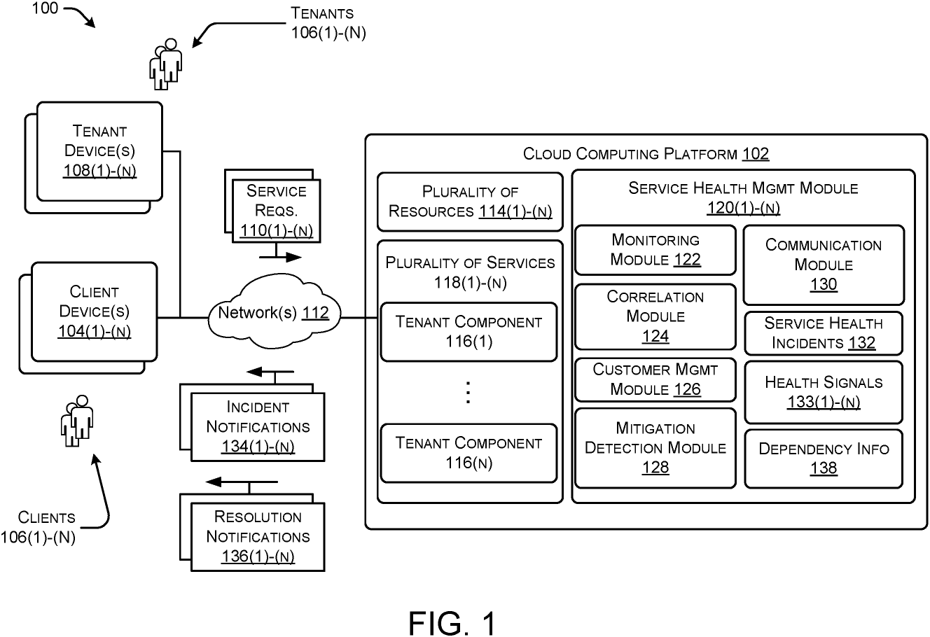

FIG. 1 is a diagram showing an example of a cloud computing system 100, in accordance with some aspects of the present disclosure. As illustrated in FIG. 1, the cloud computing system 100 may include a cloud computing platform 102, a plurality of client devices 104(1)-(n) associated with a plurality of clients 106(1)-(n), and a plurality of tenant devices 108(1)-(n) associated with a plurality of tenants 110(1)-(n). The cloud computing platform 102 may be a multi-tenant environment that provides the client devices 104(1)-(n) with access to applications, services, files, and/or data via one or more network(s) 112. In particular, the cloud computing platform 102 may implement a multi-tenant architecture wherein the resources 114(1)-(n) of the cloud computing platform 102 are shared among the tenants 110(1)-(n) but individual data associated with each tenant 110 is logically separated. As described herein, the tenants 110(1)-(n) may be customers of the cloud computing platform 102. Further, the tenants 110(1)-(n) may have relationships with the plurality of clients 106(1)-(n), and provide one or more tenant components 116(1)-(n) to the plurality of client devices 104(1)-(N) via the cloud computing platform 102.

As an example, the tenant component 116(1) may be a website, and the client device 104(1) may provide a visitor access to the website. Further, the tenant 110(1) associated with the tenant component 116(1) may employ the cloud computing platform 102 to provide features of the website (i.e., tenant component 116(1)) to the client device 104(1). For instance, the tenant component 116(1) may configure the cloud computing platform 102 to transmit the content of the website to the client device 104(1) via the network 112. As another example, the tenant component 116(2) may be a database instance and the client device 104(1) may include a tenant application that utilizes the database instance via the network 112.

The network(s) 112 may comprise any one or combination of multiple different types of networks, such as cellular networks, wireless networks, local area networks (LANs), wide area networks (WANs), personal area networks (PANs), the Internet, or any other type of network configured to communicate information between computing devices (e.g., the cloud computing platform 102, the client devices 104(1)-(N), the tenant devices 108(1)-(n)). Some examples of the client devices 104(1)-(n) and the tenant devices 108(1)-(n) include computing devices, smartphone devices, Internet of Things (IoT) devices, drones, robots, process automation equipment, sensors, control devices, vehicles, transportation equipment, tactile interaction equipment, virtual and augmented reality (VR and AR) devices, industrial machines, virtual machines, etc.

Further, each tenant component 116 may be provided via one or more services 118 of the cloud computing platform 102. Some examples of the services 118(1)-(N) include infrastructure as a service (IaaS), platform as a service (PaaS), software as a service (SaaS), database as a service (DaaS), security as a service (SECaaS, big data as a service (BDaaS), a monitoring as a service (MaaS), logging as a service (LaaS), internet of things as a service (IOTaaS), identity as a service (IDaaS), analytics as a service(AaaS), function as a service (FaaS), and/or coding as a service (CaaS). Further, the resources 114(1)-(n) may be reserved for use by the services 118(1)-(n). Some examples of the resources 114(1)-(n) include computing units, bandwidth, data storage, application gateways, software load balancers, memory, field programmable gate arrays (FPGAs), graphics processing units (GPUs), input-output (I/O) throughput, data/instruction cache, physical machines, virtual machines, clusters of virtual machines, clusters of physical machines, etc. Further, the client devices 104(1)-(n) may transmit service requests and receive service responses corresponding to the service requests in order to access the tenant components 116(1)-(n).

As described in detail herein, outages may occur on the cloud computing platform 102 and affect one or more services 118(1)-(n). For example, one or more components of a service 118 may suffer a temporary outage due to an unknown cause. As used herein, in some aspects, an “outage” may refer to a period of time during which one or more services, components, and/or features of a cloud computing platform are unavailable and/or operating at reduced capacity. As illustrated in FIG. 1, the cloud computing platform 102 may include a service health management module 120 configured to perform incident management for the plurality of services 118(1)-(n) in response to an outage. In particular, as described in detail herein, the service health management module 120 may be configured to accurately and efficiently provide service health communications to the tenants 110(1)-(n) in response to incidents impacting the tenant components 116(1)-(n).

Further, as illustrated in FIG. 1, the service health management module 120 may include at least one of a monitoring module 122, a correlation module 124, a customer management module 126, a mitigation detection module 128, and a communication module 130. The monitoring module 122 may be configured to monitor the health of the resources 114(1)-(n), the tenant components 116(1)-(n), the services 118(1)-(n), and/or service health incidents 132(1)-(n) within the cloud computing platform 102. In some aspects, the monitoring module 122 may periodically receive health signals 133(1)-(n) from at least one of the resources 114(1)-(n), the tenant components 116(1)-(n), and/or the services 118(1)-(n). Further, each health signal 133 may include at least one cloud component identifier identifying the associated cloud component (i.e., a resource 114, a tenant component 116, a service 118), a region identifier identifying a region associated with the cloud component, a time stamp, and/or a health status of the cloud component. In some aspects, a region may refer to a set of datacenters, deployed within a latency-defined perimeter and connected through a dedicated regional low-latency network. Some examples of the health status include healthy, unhealthy, degraded, inconclusive, and no signal. As such, the monitoring module 122 may determine the health of a cloud component based on the health status within the health signal 133 or failure to receive a health signal 133 within a preconfigured period of time. Further, the monitoring module 122 may generate the service health incidents 132(1)-(n) based on the health signals 133(1)-(n). In addition, the monitoring module 122 may monitor progression of a service health incident 132 from discovery to resolution.

The correlation module 124 may be configured to aggregate service health incidents 132 that correspond to a common outage within the cloud computing platform into aggregated incident information, and identify the resources 114 and/or services 118 impacted by an outage. In some aspects, the correlation module 124 may be configured to determine that two or more service health incidents 132 correspond to a common outage based on the corresponding region of each service health incident 132 and the time of impact of each service health incident 132. In some examples, the correlation module 124 may employ machine learning techniques, pattern recognition techniques, and/or heuristic techniques to aggregate the service health incidents 132. Further, the machine learning models may be trained using historic service health incident information. Consequently, the correlation module 124 may ensure that a tenant device 108 does not receive an incident notification 134 for each service health incident 132 when the service health incidents 132 are related to a common outage, thereby preventing excessive communication to a tenant device 108. Additionally, aggregating service health incidents may provide clarity to communication personnel of the cloud computing platform 102 tasked with managing outage communications.

The correlation module 124 may be further configured to determine the one or more services 118 associated with an outage (i.e., the scope of the outage). In some aspects, due to interdependencies between the services 118, a service health incident 132 may be associated with two or more services 118. In some aspects, the correlation module 124 may determine that two or more services 118 are related to an outage based on dependency information 138 identifying dependency relationships amongst the services 118. As an example, the dependency information 138 may identify that a first service 118(1) and second service 118(2) are within the outage scope of an outage based on both services 118(1)-(2) being related to a common set of resources 114. In some aspects, the dependency information 138 may include a graph representation of dependencies among the resources 114(1)-(n) and services 118(1)-(n). Further, the correlation module 124 may be configured to traverse the graph representation to identify the one or more services 118 related to a service health incident 132. In some examples, the correlation module 124 may employ machine learning techniques, pattern recognition techniques, and/or heuristic techniques to determine the scope of an outage. Further, the machine learning models may be trained using historic service health incident information. Consequently, the correlation module 124 may ensure that a tenant device 108 receives an incident notification 134 that identifies the full scope outage, thereby permitting the tenant 110 to adapt to the effects of the outage.

The customer management module 126 may be configured to determine whether any tenant components 116 are affected by a service health incident 132, and identify the tenants 110 impacted by the service health incident 132. In some aspects, the customer management module 126 may be configured to determine the tenant components 116 impacted by a service health incident 132 by identifying the tenant components 116 that have previously interacted with the resources 114 and/or services 118 associated with a service health incident 132. In some examples, the customer management module 126 may employ machine learning techniques, pattern recognition techniques, and/or heuristic techniques to determine the tenant components 116 impacted by a service health incident 132. Further, the machine learning models may be trained using historic service health incident information. In addition, in some aspects, the service health management module 120 may not transmit any incident notifications 134 to the tenant devices 108(1)-(n) when the customer management module 126 doesn’t identify a tenant component 116 impacted by the service health incident 132 even when the service health incident 132 is associated with resources 114 and/or services depended upon by the tenant components 116. Additionally, in some aspects, the customer management module 126 may periodically identify the tenant components 116 impacted by a service health incident 132 to determine if a tenant component 116 formerly impacted by a service health incident 132 is no longer impacted by a service health incident 132. Further, the customer management module 126 may periodically identify any tenant components 116 that were previously not identified as being impacted by the service health incident and currently impacted by the service health incident 132. Consequently, the customer management module 126 may ensure that only the tenants 110 impacted by a service health incident 132 receives a notification from the service health management module 120, thereby avoiding the transmission of unnecessary outage communications to tenant devices 108 that are not affected by the service health incident 132. As an example, the tenant components 116 may be configured to perform mitigative actions in response to an outage communication. As such, preventing transmission of unnecessary outage communications to tenant devices 108 may prevent unnecessary performance of mitigative actions. In some aspects, the service health management module may employ the monitoring module 122, correlation module 124, and customer management module 126 to generate an impact assessment that identifies for each outage: the impacted services 118, the impacted regions, the time of impact, the impacted resources 114, the impacted operations on the resources 114, and customer experiences with respect to the impacted services 118 and/or resources 114 (e.g., timeout, failure, etc.).

The mitigation detection module 128 may be configured to determine when a tenant 110 should be informed that an outage identified in an incident notification 134 has been resolved. In some aspects, the mitigation detection module 128 may be configured to trigger transmission of a resolution notification 136 to a tenant device 108 in response to determining that the effects of the outage on a service 118 and/or region associated with the tenant component 116(1) has been mitigated. For example, the tenant component 116(1) may be impacted by an outage affecting the service 118(1), and receive an incident notification 134(1) identifying that the tenant component 116(1) is currently impacted by a service health incident 132 affecting the service 118(1). Further, the mitigation detection module 128 may cause transmission of a resolution notification 136(1) to the tenant device 108(1) in response to determining that the amount of tenant components 116 previously identified as being impacted by the service health incident 132(1) that are no longer currently impacted by the service health incident 132(1) is greater than a preconfigured threshold value (e.g., ninety percent), and/or the amount of new net tenant components 116 impacted by the service health incident 132(1) or the amount of remaining tenant components 116 impacted by the service health incident 132(1) is less than a preconfigured ambient noise value. Alternatively, the mitigation detection module 128 may cause transmission of a resolution notification 136 in response to input received from a person (e.g., an engineer) associated with the cloud computing platform 102.

The communication module 130 may be configured to generate the incident notifications 134 and transmit the incident notifications 134 to tenant devices 108(1)-(n). In particular, the communication module 130 may generate incident notifications 134(1)-(n) for the tenant devices 108(1)-(n) in response to the aggregated incident information determined by the correlation module 124 and/or the one or more services 114 identified determined by the correlation module 124. Further, the communication module 130 may generate incident notifications 134(1)-(n) that are individually tailored for a particular tenant 110. As an example, the correlation module 124 may determine that the service health incidents 132(1)-(3) may be combined into aggregated incident information, and the services 118(1)-(4) are impacted by the service health incidents 132(1)-(3) of the aggregated incident information. Further, the customer management module 126 may determine that the tenant component 116(1) is impacted by the effects of service health incident 132(1) on the services 118(1)-(2), and tenant component 116(2) is impacted by the effects of service health incident 132(1) on the services 118(2)-(4). As a result, the communication module 130 may generate an incident notification 134(1) for the tenant device 108(1) associated with the tenant component 116(1) that provides a description of the aggregated incident information and identifies the services 118(1)-(2), and an incident notification 134(2) for the tenant device 108(2) associated with the tenant component 116(2) that provides a description of the aggregated incident information and identifies the services 118(2)-(4). Further, the communication module 130 may be configured to generate the resolution notifications 136(1)-(n) in response to a request from the mitigation detection module 128, and transmit the resolution notifications 136(1)-(n) to the tenant devices 108(1)-(n). As described above with respect to the incident notifications 134, in some aspects, the communication module 130 may generate resolution notifications 136(1)-(n) individually tailored for a tenant 110. For example, the communication module 130 may generate a resolution notification 136(1) that identifies that resolution of the outage corresponding to the service health incident 132(1) impacting the tenant component 116(1), identifies the services 118(1)-(2) that have been mitigated, and/or identifies an incident notification 134(1) corresponding to the resolution notification 136(1).

In addition, in some aspects, the communication module 130 may generate additional incident notifications 134 in response to the monitoring module 122 determining additional information about an outage, i.e., identification of a root cause of an outage, additional resources and/or services impacted by the outages, etc. Further, the communication module 130 may transmit the additional incident notifications 134 to the tenant devices 108 associated with the tenant components 116 that are currently impacted by the outage. Alternatively, in some aspects, the communication module 130 may only generate an initial incident notification 134 and a corresponding resolution notification 136 indicating that the outage has been resolved. Additionally, in some aspects, the communication module 130 may generate additional incident notifications 134 in response to the customer management module 126 identifying new tenant components 116 impacted by an outage. For example, in some aspects, the communication module 130 may periodically (e.g., every five minutes) determine any new tenant components 116 that have been impacted by a service health incident and other service health incidents associated with a common outage. Further, the communication module 130 may transmit the additional incident notifications 134 to the tenant devices 108 associated with the newly identified tenant components 116 without sending the additional incident notifications 134 to tenant devices 108 that have previously received an incident notification 134 due to the a service health incident and other service health incidents associated with a common outage. In some aspects, communications (i.e., incident notifications 134 and resolution notifications 136) related to an outage may be presented to a tenant 110 in message thread format. For example, a tenant 110 may be presented a plurality of communications sharing a same tracking identifier under one message thread. In some aspects, a tracking identifier may refer to a human readable alphanumeric string generated from an internal identifier. Once a service 118 is considered part of an outage, any communications from that service 118 will be associated with the tracking identifier of the outage and presented within the thread.

Additional, or alternatively, in some aspects, the communication module 130 may be configured to associate aggregated incident information (e.g., impact information corresponding to one or more service health incidents 132) with a service action performed by a service, e.g., modifying a tenant component 116. Further, in some aspects, in response to a request to perform the service action, the communication module 130 may present an error communication within a graphical user interface that includes a standard error communication associated with the service action and an in-place error communication associated with the aggregated incident information. For example, the service 118 may receive the service request from a tenant device 108(1), and the communication module 130 may present an error communication identifying the failure to perform a service action corresponding to the service request and an in-place error communication describing the service health incident impacting the service 118(1). As such, the communication module 130 may provide additional error information to customers attempting to perform service actions impacted by an outage. In some aspects, the in-place error communication may further include one or more mitigation recommendations, and/or be provided to tenant devices 108 instead of an incident notification 134.

In yet still some other aspects, the communication module 130 may be configured to transmit an incident notification 134 and/or a resolution notification to a person (e.g., an engineer) associated with the cloud computing platform 102. Further, the person may determine whether to forward or otherwise communicate the incident notification 134 and/or a resolution notification 136 and/or information related to the incident notification 134 and/or a resolution notification 136 to the relevant tenant devices 108 and/or tenants 110.

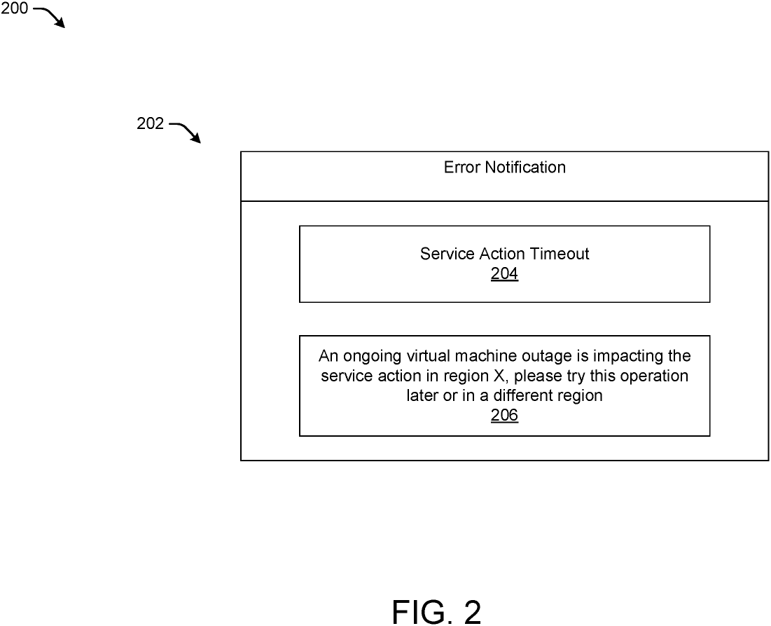

FIG. 2 illustrates an example of a graphical user interface 200 displaying incident information, in accordance with some aspects of the present disclosure. As illustrated in FIG. 2, the graphical user interface 200 may include present a visual notification 202 in response to an attempt to perform a service action by a service 118 currently impacted by an outage. Further, the visual notification 202 may present standard error communication information 204 indicating that the service action request has failed, and in-place communication error information 206 representing aggregate incident information describing the outage.

### Example Process

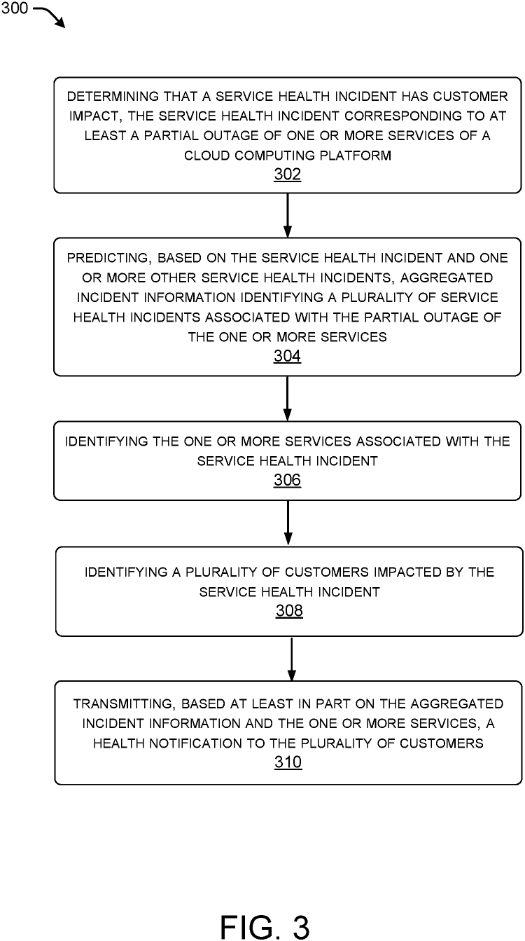

The described processes in FIG. 3 below are illustrated as a collection of blocks in a logical flow graph, which represent a sequence of operations that can be implemented in hardware, software, or a combination thereof. In the context of software, the blocks represent computer-executable instructions stored on one or more computer-readable media that, when executed by one or more processors, perform the recited operations. Computer-readable media includes computer storage media, which may be referred to as non-transitory computer-readable media. Non-transitory computer-readable media may exclude transitory signals. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. The operations described herein may, but need not, be implemented using the cloud computing platform 102. By way of example and not limitation, the method 300 is described in the context of FIGS. 1-2 and 4. For example, the operations may be performed by one or more of the monitoring module 122, the correlation module 124, the customer management module 126, the mitigation detection module 128, and the communication module 130.

FIG. 3 is a flow diagram illustrating an example method for implementing intelligent cloud service health communications, in accordance with some aspects of the present disclosure.

At block 302, the method 300 may include determining that a service health incident has customer impact, the service health incident corresponding to an outage of one or more services of a cloud computing platform. For example, the monitoring module 122 may receive a service health incident 132(1), and the customer management module 126 may determine whether the service health incident 132(1) has customer impact on one of the tenant components 116(1)-(n).

Accordingly, the cloud computing platform 102, the cloud computing device 400, and/or the processor 402 executing the customer management module 126 may provide means for determining that a service health incident has customer impact, the service health incident corresponding to an outage of one or more services of a cloud computing platform.

At block 304, the method 300 may include predicting, based on the service health incident and one or more other service health incidents, aggregated incident information identifying a plurality of service health incidents associated with the outage of the one or more services. For example, the correlation module may determine that the service health incident 132(1) is associated with the same outage event as service health incidents 132(2)-(4) to determine aggregated incident information for the outage event.

Accordingly, the cloud computing platform 102, the cloud computing device 400, and/or the processor 402 executing the correlation module 124 may provide means for predicting, based on the service health incident and one or more other service health incidents, aggregated incident information identifying a plurality of service health incidents associated with the outage of the one or more services.

At block 306, the method 300 may include identifying the one or more services associated with the service health incident. For example, the correlation module 124 may determine that the services 118(1)-(2) are impacted by the outage event represented by the aggregated incident information. In some aspects, the correlation module 124 may determine the services 118(1)-(2) correspond the same outage based on dependency information 138 identifying a dependency relationships between the services 118(1)-(2).

Accordingly, the cloud computing platform 102, the cloud computing device 400, and/or the processor 402 executing the correlation module 124 may provide means for identifying the one or more services associated with the service health incident.

At block 308, the method 300 may include identifying a plurality of customers impacted by the service health incident. For example, in some aspects, the customer management module 126 may determine that the tenant component 116(1) is impacted by the service health incident 132(1) by identifying that the tenant component 116(1) has previously interacted with one or more resources 114 and/or services 118 associated with the service health incident 132(1). In addition, the customer management module 126 may identify the tenant 110 associated with the tenant component 116(1).

Accordingly, the cloud computing platform 102, the cloud computing device 400, and/or the processor 402 executing the customer management module 126 may provide means for identifying a plurality of customers impacted by the service health incident.

At block 310, the method 300 may include transmitting, based at least in part on the aggregated incident information and the one or more services, a health notification to the plurality of customers. For example, the communication module 130 may transmit an incident notification 134(1) to the tenant device 108(1) associated with the tenant component 116(1) that are impacted by the service health incident 132(1).

Accordingly, the cloud computing platform 102, the cloud computing device 400, and/or the processor 402 executing the communication module 130 may provide means for transmitting, based at least in part on the aggregated incident information and the one or more services, a health notification to the plurality of customers.

In an additional aspect, in order to identify the plurality of customers impacted by the service health incident, the method 300 may include determine one or more resources associated with the service health incident, and identify the plurality of customers based on historic information indicating use of the one or more resources by the plurality of customers. For example, the customer management module 126 may determine the tenant components 116 impacted by a service health incident 132 by identifying the tenant components 116 that have previously interacted with the resources 114 and/or services 118 associated with a service health incident 132. Accordingly, the cloud computing platform 102, the cloud computing device 400, and/or the processor 402 executing the customer management module 126 may provide means for determining one or more resources associated with the service health incident, and identifying the plurality of customers based on historic information indicating use of the one or more resources by the plurality of customers.

In an additional aspect, the health notification is a first health notification, the plurality of customers are a first plurality of customers, and the method 300 may include monitoring the service health incident to identify a second plurality of customers impacted by the service health incident, and transmitting, based at least in part on the aggregated incident information and the one or more services, a second health notification to the second plurality of customers. For example, the communication module 130 may periodically (e.g., every five minutes) determine any new tenant components 116 that have been impacted by a service health incident 132 and other service health incidents 132 associated with a common outage. Further, the communication module 130 may transmit additional incident notifications 134 to the tenant devices 108 associated with the newly identified tenant components 116 without sending the additional incident notifications 134 to tenant devices 108 that have previously received an incident notification 134 due to the outage. Accordingly, the cloud computing platform 102, the cloud computing device 400, and/or the processor 402 executing the monitoring module 122, the customer management module 126, and the communication module 130 may provide means for monitoring the service health incident to identify a second plurality of customers impacted by the service health incident, and transmitting, based at least in part on the aggregated incident information and the one or more services, a second health notification to the second plurality of customers.

In an additional aspect, the aggregated incident information is original aggregated incident information, the health notification is a first health notification, and the method 300 may include monitoring the service health incident to identify updated aggregated incident information, and transmitting, based at least in part on the updated aggregated incident information, a second health notification to the plurality of customers. For example, the communication module 130 may generate additional incident notifications 134 in response to the monitoring module 122 determining additional information about an outage. Further, the communication module 130 may transmit the additional incident notifications 134 to the tenant devices 108 associated with the tenant components 116 that are currently impacted by the outage. Accordingly, the cloud computing platform 102, the cloud computing device 400, and/or the processor 402 executing the monitoring module 122, the correlation module 124, and the communication module 130 may provide means for monitoring the service health incident to identify updated aggregated incident information, and transmitting, based at least in part on the updated aggregated incident information, a second health notification to the plurality of customers.

In an additional aspect, the service health incident is a first service health incident, and to predict aggregated incident information, the method 300 may include determining first region information associated with the first service health incident, determining second region information associated with a second service health incident, and generating, based on the first region information and the second region information, the aggregate incident information indicating that the first service health incident and the second service health incident correspond to the outage of the one or more services. For example, the correlation module 124 may be configured to determine that two or more service health incidents 132 correspond to a common outage based on the corresponding region of each service health incident 132 and the time of impact of each service health incident 132. Accordingly, the cloud computing platform 102, the cloud computing device 400, and/or the processor 402 the correlation module 124 may provide means for determining first region information associated with the first service health incident, determining second region information associated with a second service health incident, and generating, based on the first region information and the second region information, the aggregate incident information indicating that the first service health incident and the second service health incident correspond to the outage of the one or more services.

In an additional aspect, in order to identify the one or more services associated with the service health incident, the method 300 may include predicting, via a machine learning model, the one or more or services based on dependency information and/ or historic incident information identifying relationships between a first service associated with the service health incident and a plurality of other services. For instance, the correlation module 124 may determine that two or more services 118 are related to an outage based on dependency information 138 identifying dependency relationships amongst the services 118. As an example, the dependency information 138 may identify that a first service 118(1) and second service 118(2) are within the outage scope of an outage based on the both services 118(1)-(2) being related to a common set of resources 114. Additionally, or alternatively, the correlation module 124 may determine that two or more services 118 are related to an outage based on one or more previous incidents identifying dependency relationships amongst the services 118. Accordingly, the cloud computing platform 102, the cloud computing device 400, and/or the processor 402 executing the correlation module 124 may provide means for predicting, via a machine learning model, the one or more or services based on dependency information identifying relationships between a first service associated with the service health incident and a plurality of other services.

In an additional aspect, the service is a first service, and in order to predict the aggregated incident information, the method 300 may include determining that a number of customers currently impacted by the service health incident is less than a preconfigured threshold, and transmitting a resolved notification to the plurality of customers in response to the number being less than the preconfigured threshold. The mitigation detection module 128 may cause transmission of a resolution notification 136(1) to the tenant device 108(1) via the communication module 130 in response to determining that the amount of tenant components 116 previously-identified as being impacted by the service health incident 132(1) that are no longer currently impacted by the service health incident 132(1) is greater than a preconfigured threshold value (e.g., ninety percent) and/or the amount of new net tenant components 116 impacted by the service health incident 132(1) is less than a preconfigured ambient noise value. Accordingly, the cloud computing platform 102, the cloud computing device 400, and/or the processor 402 executing the customer management module 126, the mitigation detection module 128, and/or the communication module 130 may provide means for determining that a number of customers currently impacted by the service health incident is less than a preconfigured threshold, and transmitting a resolved notification to the plurality of customers in response to the number being less than the preconfigured threshold.

In an additional aspect, the service is a first service, and in order to predict the aggregated incident information, the method 300 may include receiving a request to perform a service action associated with the service health incident, and displaying, based at least in part on the relationship, a standard error communication associated with the service action and an in-place error communication associated with the service health incident. For example, the service 118 may receive the service request from a tenant device 108(1), and the communication module 130 may present a standard error communication information 204 identifying the failure to perform a service action corresponding to the service request and an in-place error communication information 206 describing the service health incident impacting the service 118(1). Accordingly, the cloud computing platform 102, the cloud computing device 400, and/or the processor 402 executing the communication module 130 may provide means for receiving a request to perform a service action associated with the service health incident, and displaying, based at least in part on the relationship, a standard error communication associated with the service action and an in-place error communication associated with the service health incident.

In an additional aspect, in order to transmit the health notification, the method 300 may include determining that a customer of the plurality of customers employs a first service of the one or more services and not a second service of the one or more services, and transmitting the health notification to the customer with service information corresponding to the first service and not the second service. For example, the correlation module 124 may determine that the service health incidents 132(1)-(3) may be combined into aggregated incident information, and the services 118(1)-(4) are impacted by the service health incidents 132(1)-(3) of the aggregated incident information. Further, the customer management module 126 may determine that the tenant component 116(1) is impacted by the effects of service health incident 132(1) on the services 118(1)-(2). As a result, the communication module 130 may generate an incident notification 134(1) for the tenant device 108(1) associated with the tenant component 116(1) that provides a description of the aggregated incident information and identifies the services 118(1)-(2). Accordingly, the cloud computing platform 102, the cloud computing device 400, and/or the processor 402 executing the customer management module 126 and/or the communication module 130 may provide means for determining that a customer of the plurality of customers employs a first service of the one or more services and not a second service of the one or more services, and transmitting the health notification to the customer with service information corresponding to the first service and not the second service.

While the operations are described as being implemented by one or more computing devices, in other examples various systems of computing devices may be employed. For instance, a system of multiple devices may be used to perform any of the operations noted above in conjunction with each other.

### Illustrative Computing Device

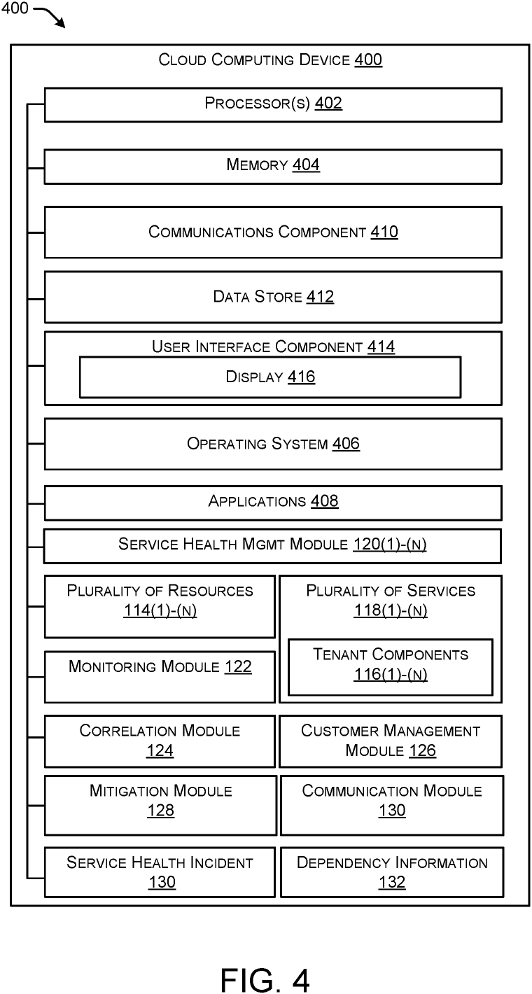

Referring now to FIG. 4, a cloud computing device 400 (e.g., cloud computing platform 102) in accordance with an implementation includes additional component details as compared to FIG. 1. In one example, the cloud computing device 400 includes a processor 402 for carrying out processing functions associated with one or more of components and functions described herein. The processor 402 can include a single or multiple set of processors or multicore processors. Moreover, the processor 402 may be implemented as an integrated processing system and/or a distributed processing system. In an example, the processor 402 includes, but is not limited to, any processor specially programmed as described herein, including a controller, microcontroller, a computer processing unit (CPU), a graphics processing unit (GPU), an application specific integrated circuit (ASIC), a field programmable gate array (FPGA), a system on chip (SoC), or other programmable logic or state machine. Further, the processor 402 may include other processing components such as one or more arithmetic logic units (ALUs), registers, or control units.

In an example, the cloud computing device 400 also includes memory 404 for storing instructions executable by the processor 402 for carrying out the functions described herein. The memory 404 may be configured for storing data and/or computer-executable instructions defining and/or associated with the operating system 406, the resources 114(1)-(n), the tenant components 114(1)-(n), the services 118(1)-(n), the monitoring module 122, the correlation module 124, the customer management module 126, the mitigation detection module 128, the communication module 130, one or more applications 408, and the processor 402 may execute the operating system 406, the tenant components114(1)-(n), the services 118(1)-(n), the monitoring module 122, the correlation module 124, the customer management module 126, the mitigation detection module 128, the communication module 130, and/or the one or more applications 408. An example of the memory 404 may include, but is not limited to, a type of memory usable by a computer, such as random access memory (RAM), read only memory (ROM), tapes, magnetic discs, optical discs, volatile memory, non-volatile memory, and any combination thereof. In an example, the memory 404 may store local versions of applications being executed by processor 402.

The example cloud computing device 400 also includes a communications component 410 that provides for establishing and maintaining communications with one or more parties utilizing hardware, software, and services as described herein. The communications component 410 may carry communications between components on the cloud computing device 400, as well as between the cloud computing device 400 and external devices, such as devices located across a communications network and/or devices serially or locally connected to the cloud computing device 400. For example, the communications component 410 may include one or more buses, and may further include transmit chain components and receive chain components associated with a transmitter and receiver, respectively, operable for interfacing with external devices. In an implementation, for example, the communications component 410 may include a connection to communicatively couple the client devices 104(1)-(N) to the processor 402.

The example cloud computing device 400 also includes a data store 412, which may be any suitable combination of hardware and/or software, that provides for mass storage of information, databases, and programs employed in connection with implementations described herein. For example, the data store 412 may be a data repository for the operating system 406 and/or the applications 408.

The example cloud computing device 400 also includes a user interface component 414 operable to receive inputs from a user of the cloud computing device 400 and further operable to generate outputs for presentation to the user. The user interface component 414 may include one or more input devices, including but not limited to a keyboard, a number pad, a mouse, a touch-sensitive display (e.g., display 416), a digitizer, a navigation key, a function key, a microphone, a voice recognition component, any other mechanism capable of receiving an input from a user, or any combination thereof. Further, the user interface component 414 may include one or more output devices, including but not limited to a display (e.g., display 416), a speaker, a haptic feedback mechanism, a printer, any other mechanism capable of presenting an output to a user, or any combination thereof.

In an implementation, the user interface component 414 may transmit and/or receive messages corresponding to the operation of the operating system 406 and/or the applications 408. In addition, the processor 402 executes the operating system 406 and/or the applications 408, and the memory 404 or the data store 412 may store them.

Further, one or more of the subcomponents of the tenant components 114(1)-(n), the services 118(1)-(n), the monitoring module 122, the correlation module 124, the customer management module 126, the mitigation detection module 128, the communication module 130, one or more applications 408, may be implemented in one or more of the processor 402, the applications 408, the operating system 406, and/or the user interface component 414 such that the subcomponents of the tenant components 114(1)-(n), the services 118(1)-(n), the monitoring module 122, the correlation module 124, the customer management module 126, the mitigation detection module 128, the communication module 130, one or more applications 408, are spread out between the components/subcomponents of the cloud computing device 400.

### Conclusion

In closing, although the various embodiments have been described in language specific to structural features and/or methodological acts, it is to be understood that the subject matter defined in the appended representations is not necessary limited to the specific features or acts described. Rather, the specific features and acts are disclosed as example forms of implementing the claimed subject matter.

What is claimed is:

1. A cloud computing device comprising:
a memory storing instructions; and
at least one processor coupled with the memory and configured to execute the instructions to:
determine that a service health incident has customer impact, the service health incident corresponding to an outage of one or more services of a cloud computing platform;
predict, based on the service health incident and one or more other service health incidents, aggregated incident information identifying a plurality of service health incidents associated with the outage of the one or more services;
identify the one or more services associated with the service health incident;
identify a plurality of customers impacted by the service health incident; and
transmit, based at least in part on the aggregated incident information and the one or more services, a health notification to the plurality of customers impacted by the service health incident.

2. The cloud computing device of claim 1, wherein to identify the plurality of customers impacted by the service health incident, the at least one processor is further configured to:
determine one or more resources associated with the service health incident; and
identify the plurality of customers based on historic information indicating use of the one or more resources by the plurality of customers.

3. The cloud computing device of claim 1, wherein the health notification is a first health notification, the plurality of customers are a first plurality of customers, and the at least one processor is further configured to:
monitor the service health incident to identify a second plurality of customers impacted by the service health incident; and
transmit, based at least in part on the aggregated incident information and the one or more services, a second health notification to the second plurality of customers.

4. The cloud computing device of claim 1, wherein the aggregated incident information is original aggregated incident information, the health notification is a first health notification, and the at least one processor is further configured to:
monitor the service health incident to identify updated aggregated incident information; and
transmit, based at least in part on the updated aggregated incident information, a second health notification to the plurality of customers.

5. The cloud computing device of claim 1, wherein the service health incident is a first service health incident, and to predict the aggregated incident information, the at least one processor is further configured to:
determine first region information associated with the first service health incident;
determine second region information associated with a second service health incident; and
generate, based on the first region information and the second region information, the aggregate incident information indicating that the first service health incident and the second service health incident correspond to the outage of the one or more services.

6. The cloud computing device of claim 1, wherein to identify the one or more services associated with the service health incident, the at least one processor is further configured to:
predict, via a machine learning model, the one or more or services based on dependency information identifying relationships between a first service associated with the service health incident and a plurality of other services.

7. The cloud computing device of claim 1, wherein the at least one processor is further configured to:
determine that a number of customers currently impacted by the service health incident is less than a preconfigured threshold; and
transmit a resolved notification to the plurality of customers in response to the number being less than the preconfigured threshold.

8. The cloud computing device of claim 1, wherein to predict the aggregated incident information, the at least one processor is further configured to:
receive a request to perform a service action impacted by the service health incident; and
display a standard error communication associated with the service action and an in-place error communication associated with the service health incident.

9. The cloud computing device of claim 1, wherein to transmit the health notification, the at least one processor is further configured to:
determine that a customer of the plurality of customers employs a first service of the one or more services and not a second service of the one or more services; and
transmit the health notification to the customer with service information corresponding to the first service and not the second service.

10. A method comprising:
determining that a service health incident has customer impact, the service health incident corresponding to an outage of one or more services of a cloud computing platform;
identifying a plurality of customers impacted by the service health incident;
predicting, based on the service health incident and one or more other service health incidents, aggregated incident information identifying a plurality of service health incidents associated with the outage of the one or more services;
identifying the one or more services associated with the service health incident; and
transmitting, based at least in part on the aggregated incident information and the one or more services, a health notification to the plurality of customers.

11. The method of claim 10, wherein identifying the plurality of customers impacted by the service health incident, comprises:
determining one or more resources associated with the service health incident; and
identifying the plurality of customers based on historic information indicating use of the one or more resources by the plurality of customers.

12. The method of claim 10, wherein the health notification is a first health notification, the plurality of customers are a first plurality of customers, and further comprising:
monitoring the service health incident to identify a second plurality of customers impacted by the service health incident; and
transmitting, based at least in part on the aggregated incident information and the one or more services, a second health notification to the second plurality of customers.

13. The method of claim 10, wherein the aggregated incident information is original aggregated incident information, the health notification is a first health notification, and further comprising:
monitoring the service health incident to identify updated aggregated incident information; and
transmitting, based at least in part on the updated aggregated incident information, a second health notification to the plurality of customers.

14. The method of claim 10, wherein the service health incident is a first service health incident, and predicting the aggregated incident information, comprises:
determining first region information associated with the first service health incident;
determining second region information associated with a second service health incident; and
generating, based on the first region information and the second region information, the aggregate incident information indicating that the first service health incident and the second service health incident correspond to the outage of the one or more services.

15. The method of claim 10, wherein predicting the aggregated incident information, comprises: predicting, via a machine learning model, the one or more or services based on dependency information identifying relationships between a first service associated with the service health incident and a plurality of other services..

16. A non-transitory computer-readable device having instructions thereon that, when executed by at least one computing device, causes the at least one computing device to perform operations comprising:
determining that a service health incident has customer impact, the service health incident corresponding to an outage of one or more services of a cloud computing platform;
identifying a plurality of customers impacted by the service health incident;
predicting, based on the service health incident and one or more other service health incidents, aggregated incident information identifying a plurality of service health incidents associated with the outage of the one or more services;
identifying the one or more services associated with the service health incident; and
transmitting, based at least in part on the aggregated incident information and the one or more services, a health notification to the plurality of customers.

17. The non-transitory computer-readable device of claim 16, wherein identifying the plurality of customers impacted by the service health incident, comprises:
determining one or more resources associated with the service health incident; and
identifying the plurality of customers based on historic information indicating use of the one or more resources by the plurality of customers.

18. The non-transitory computer-readable device of claim 16, wherein the health notification is a first health notification, the plurality of customers are a first plurality of customers, and further comprising:
monitoring the service health incident to identify a second plurality of customers impacted by the service health incident; and
transmitting, based at least in part on the aggregated incident information and the one or more services, a second health notification to the second plurality of customers.

19. The non-transitory computer-readable device of claim 16, wherein predicting the aggregated incident information, comprises: predicting, via a machine learning model, the one or more or services based on dependency information identifying relationships between a first service associated with the service health incident and a plurality of other services.

20. The non-transitory computer-readable device of claim 16, herein the service health incident is a first service health incident, and predicting the aggregated incident information, comprises:
determining first region information associated with the first service health incident;
determining second region information associated with a second service health incident; and
generating, based on the first region information and the second region information, the aggregate incident information indicating that the first service health incident and the second service health incident correspond to the outage of the one or more services.
